(19) United States
(12) Patent Application Publication
(10) Pub. No.: US 2010/0213653 A1
(43) Pub. Date: Aug. 26, 2010

(54) Device for the Secured Mounting of an Anti-Vibration Actuator on an Automobile

(75) Inventors: Stéphane Lanotte, Saint Maur Des Fosses (FR); Jacques Dusi, Gretz Armainvilliers (FR); Albert Alarcon Cot, Boulogne Billancourt (FR)

Correspondence Address: Polster, Lieder, Woodruff & Lucchesi, L.C., 12412 Powerscourt Dr. Suite 200, St. Louis, MO, 63131-3615, US

(73) Assignee: PEUGEOT CITROEN AUTOMOBILES SA, Velizy Villacoublay (FR)

(21) Appl. No.: 12/676,533

(22) PCT Filed: Aug. 22, 2008
(86) PCT No.: PCT/FR2008/051521

§ 371 Date: Apr. 29, 2010

(30) Foreign Application Priority Data
Sep. 11, 2007 (FR) 0757504

(51) Int. Cl. F16F 15/02; F16F 15/03; F16F 15/08; F16B 1/00

(52) U.S. Cl. 267/140.14; 403/286

(57) ABSTRACT

The invention relates to a device for mounting an anti-vibration actuator on an automobile. The device comprises a fastening screw for attaching the actuator on a wall of a frame of the vehicle. The main characteristic of the mounting device is that it comprises a slide attached to the vehicle frame wall, and that the actuator comprises a protrusion capable of being inserted into the slide (19, 29, 39) so that the actuator has two connection points to the wall.

### CROSS-REFERENCE TO RELATED APPLICATIONS

The present application is the US National Stage under 35 U.S.C. §371 of International Application Number PCT/FR2008/051521having an international filing date of Aug. 22, 2008, and which claims priority to French application number 0757504 filed on Sep. 11, 2007, the content of which (description, claims and drawings) is incorporated herein by reference.

### BACKGROUND

The technical domain of the invention relates to controlled type anti-vibration systems that are installed in automotive vehicles, and of which the vibration frequency is regulated in order to reduce, or even eliminate, the vibrations produced by the engine. In general, these controlled actuators are attached by means of a bolt to the body of the vehicle, and the risk of these actuators falling accidentally on the road is not negligible. The consequences of such an event are dreadful because of possible pedestrian injuries and material damage caused to other surrounding vehicles. The goal of the present invention is a mounting device for anti-vibration actuators that guarantees increased security against accidental loss of these actuators.

Devices for mounting anti-vibration systems on the body of an automotive vehicle already exist and have been the subject of patents. For instance, patent JP 2004169913 can be cited, which discloses a device for mounting an anti-vibration system on the body of a vehicle with two mounting bolts. In this manner, in case of accidental breakage of one of the two bolts, the other maintains the system solidly attached to the body, thus preventing its fall. In the configuration described in this patent, the two bolts are mounted on the same wall of the vehicle body. Mounting devices with two bolts are heavier due to a non-functional element, consisting of the second bolt. In addition, this second bolt increases the space occupied by said mounting device. Finally, devices with two bolts are not easily installed on certain vehicles because the center distance between said bolts is greater than the dimensions of the actuator, which makes the bolts difficult to access with certain tools, like for instance torque wrenches.

### BRIEF SUMMARY

Mounting devices according to the invention allow the installation of anti-vibration systems in automotive vehicles by means that prevent accidental loss of these systems, thus eliminating the aforementioned problems.

The goal of the present invention is a device for mounting an anti-vibration actuator in an automotive vehicle, comprising a bolt for mounting said actuator on a wall of said vehicle body. The main characteristic of a mounting device according to the invention is that it is equipped with a slideway attached to said wall, and that the actuator comprises a protuberance that fits in said slideway, so that said actuator has two attachment points in said wall. For clarity reasons and for good understanding of the description, we assume that the slideway contains, in systemic manner, a groove. In this configuration, the anti-vibration device comprises, besides the main mounting bolt, a second anchoring point to the body, which does not require the intervention of a torque wrench or any other tool. In addition, there is no constraint, relative to this bolt, regarding the location where this second anchoring point is installed. The protuberance is introduced in the slideway from the side, and slides laterally along a plane parallel to the plane of the wall. It is clear that a vehicle can be equipped with several of these mounting devices, if it must support several anti-vibration actuators.

Advantageously, the slideway comprises a groove provided with a bored hole, allowing the bolt to pass through said slideway. In this way, the bolt is used for mounting both the anti-vibration actuator and the slideway to the wall of the body.

In preferred manner, the protuberance is elongated, and the axis of the bolt is parallel to the longitudinal axis of said protuberance.

In an advantageous manner, the protuberance has a central canal for passage of the bolt. Although the axes of bolt and protuberance are coinciding, in this configuration the two anchoring points remain distinct. Since the two anchoring points are created on the same surface element of the wall, the space occupied by the device according to the invention is minimal.

Preferably, the protuberance comprises a cylindrical body terminating in a flared cylindrical end. In other words, it is this flared end that is inserted in the groove of the slideway for lateral sliding.

Advantageously, the slideway is equipped with a positioning stop for the protuberance. In preferential manner, the stop is located in one extremity of the slideway, opposite to the extremity through which said protuberance is introduced. The protuberance is introduced in the slideway until it is arrested by said stop.

In an advantageous manner, the actuator comprises a core of soft steel, prolonged by the protuberance, while the bolt passes through these two continuous elements. The bolt, the protuberance and the soft steel core represent the fixed parts of said actuator.

In an advantageous manner, the soft steel core is surrounded by a magnetic coil and a rubber spring, and said spring is located between the wall and said coil. Under the influence of an electric current and of the soft steel core, the coil starts to vibrate. The rubber spring has a conical shape and takes up these vibrations.

Preferably, the core is blocked in translation relative to the bolt, by means of a washer and a nut, located in one extremity of said core.

In an advantageous manner, the slideway is equipped with an anti-backup device, which prevents the protuberance from moving in the opposite direction of insertion in said slideway. Indeed, to avoid loss of the actuator in case of bolt breakage, the protuberance must be prevented from moving out of the slideway. Since the slideway is provided with a fixed stop on one side, a removable stop must be installed on the other side, which allows the introduction of the protuberance in the slideway, but prevents its extraction in the other direction.

According to a first preferred implementation mode of the invention, the anti-backup device is comprised of a leaf spring, suitable to deform during the insertion of the protuberance in the slideway, and suitable to resume its relaxed position, after passage of said protuberance.

According to a second preferred implementation mode of the invention, the anti-backup device is comprised of a set screw emerging in the groove of the slideway. In this manner, once the protuberance is placed against the stop at the end of the slideway, the set screw is introduced in the groove of the slideway to prevent the return of the protuberance.

The invention relates also to an automobile comprising a mounting device for an anti-vibration device conformed to the invention.

Mounting devices according to the invention have the advantage of occupying less space and being easy to implement, because the two mounting points of the actuator, although distinct, are located in the same spot on the body of the vehicle, and the second mounting point is designed so that it does not require the use of a heavy and complex tool for its installation. Finally, they are reliable because the attaching mechanisms to the body are of simple design.

### BRIEF DESCRIPTION OF THE SEVERAL VIEWS OF THE DRAWINGS

Below follows a detailed description of a preferred implementation mode of a mounting structure according to the invention with reference to FIGS. 1 to 5.

FIG. 1 is a view of an axial, longitudinal section of an anti-vibration actuator and its mounting device according to the prior art.

FIG. 2 is a view of a longitudinal section of an anti-vibration actuator and its mounting device according to the invention.

FIG. 3 is a sectional view along plane III-III of the actuator and its mounting device shown in FIG. 2.

FIG. 4 is a frontal view of a first preferred implementation mode of the slideway of a mounting device according to the invention.

FIG. 5 is a frontal view of a second preferred implementation mode of a slideway of a mounting device according to the invention.

### DETAILED DESCRIPTION

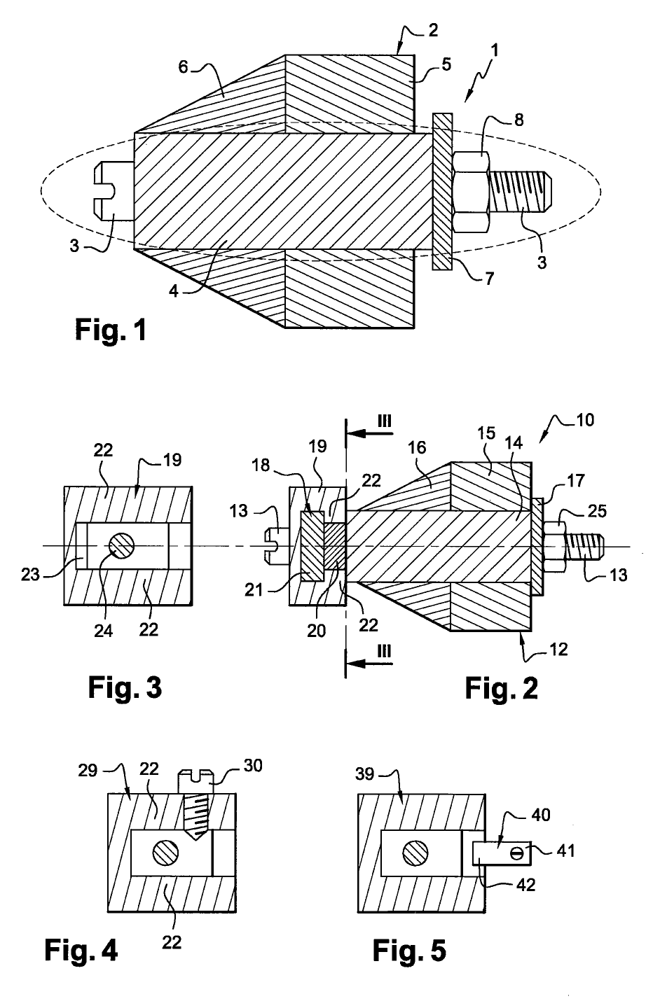

With reference to FIG. 1, a prior art mounting device 1, for mounting an anti-vibration actuator 2 on the body of an automotive vehicle, comprises a single bolt 3, passing through an actuator 2, and suitable for attaching the device to a wall (not shown) of the body of an automotive vehicle. Actuator 2 comprises a cylindrical shaped soft steel core 4 with a central canal, around which are placed a cylindrical hollow coil 5, and a conical shaped rubber spring 6. The spring 6 is located between the body wall on which the actuator 2 is mounted, and coil 5. The soft steel core 4 amplifies the magnetic field created by the coil 5. Through successive inversions of the electrical current circulating through the coil 5, the coil 5 vibrates around the core 4 along its longitudinal axis, this movement is taken up by the rubber spring 6. Bolt 3 passes from end to end through the soft steel core 4 and is housed in its central canal. Core 4 is blocked in translation relative to the bolt 3 by means of a washer 7 and a nut 8 located at the extremity of the core 4, opposite to the extremity located against the wall of the vehicle body.

With reference to FIG. 2, a mounting device 10 according to the invention differentiates itself from the prior art mounting device 1 as described above, by the fact that the anti-vibration actuator 12 comprises a second attachment point to the wall, in the form of a protuberance 18 belonging to the actuator 12, and suitable for being inserted in a slideway 19 installed on the wall. Protuberance 18 comprises a cylindrical body 20 prolonging the soft steel core 14, the body 20 terminates in a widened cylindrical end 21. Slideway 19 is comprised of a rectangular shaped flat part, of which two opposite edges 22 are folded towards the interior of the part. The two opposite edges 22, formed in this manner, are parallel to each other, and are located in the same plane which is parallel to the plane defined by the surface of the part. In other words, the part has two opposite elbows, each making an angle of 180°. These two elbows create an empty space between the two edges 22 and the surface of the part. The distance between the two edges 22 is approximately equal to the diameter of body 20 of protuberance 18, and the distance between the bottoms of the folds of each elbow is approximately equal to the diameter of the widened cylindrical end 21. The space situated between the two edges 22 defines in this way a groove. Perpendicular to the longitudinal axis of the two edges 22, the slideway 19 has a protrusion 23, serving as stop for protuberance 18, once the protuberance is introduced in the groove of the slideway 19. Protuberance 18 has a central canal, passing through body 20 and widened end 21; the canal has the same dimensions as the canal passing through the soft steel core, and the two canals are in continuity with each other. The resulting canal passes from one end to the other, through the anti-vibration actuator 12. At the bottom of the groove, slideway 19 has a bored hole 24. The dimensions of protuberance 18, and the position of stop 23 of slideway 19, are adjusted in order to line up bored hole 24 with the central canal of actuator 12. A mounting bolt 13 passes through the central canal and said bored hole 24 to attach the actuator 12 on the wall of the vehicle body. Core 14 is blocked in translation relative to the bolt 13, by means of a washer 17 and a nut 25 located at the extremity of said core 14, which is opposite to the extremity prolonged by the protuberance 18. Similar to the anti-vibration actuators of the prior art, the actuators 12 according to the invention comprise also a coil 15 and a conical shaped rubber spring 16, arranged around the soft steel core 14, while said spring 16 is located between slideway 19 and coil 15.

With reference to FIG. 4, a first preferred implementation mode of the invention involves a slideway 29 equipped with an anti-backup device in the form of a set screw 30 inserted in the slideway 29 and emerging in the groove. A hole is made in one of the two edges 22 of the flat part, which constitute the slideway 29. The axis of this hole is perpendicular to the longitudinal axis of said edge 22.

The actuator 12 is mounted on the wall of the vehicle body first by introducing the widened end 21 of the protuberance 18 in the groove of slideway 29. This end 21 is brought in contact with stop 23, then actuator 12 is fixed to the wall by means of bolt 13. Set screw 30 is then inserted in the groove, to prevent protuberance 18 from backing out.

With reference to FIG. 5, a second preferred implementation mode of the invention involves a slideway 39 equipped with an anti-backup device in the form of a leaf spring 40. This leaf spring 40 is rigid and in a relaxed state creates an angle with the bottom of the groove. Relative to the direction that protuberance 18 is introduced in slideway 39, the leaf spring has an upstream part 41 and a downstream part 42, and is attached to the bottom of the groove at the location of said upstream part 41.

The anti-vibration actuator 12 is mounted on the wall of the vehicle body first by introducing the widened end 21 of the protuberance in the slideway 39. This end passes over the leaf spring 40, which bends to come in contact with the bottom of the groove. Once the end 21 has moved beyond the leaf spring 40, the leaf spring returns to its relaxed position, and the end 21 is then brought in contact with the stop 23. Then, the actuator is fixed to the wall by means of bolt 13.

1. A device for mounting an anti-vibration actuator on an automotive vehicle body having a wall, comprising a bolt for mounting said actuator on the wall of said vehicle body, wherein said device comprises a slideway securable to said wall, and wherein said actuator comprises a protuberance sized and shaped to be inserted in said slideway, so that said actuator has two attachment points to said wall.

2. The device according to claim 1, wherein the slideway comprises a groove provided with a hole, through which the bolt can pass, whereby, the bolt can pass through said slideway.

3. The device according to any of claim 1, wherein the protuberance is elongated, and the axis of the bolt is parallel to the longitudinal axis of said protuberance.

4. The device according to claim 3, wherein protuberance has a central canal through which the bolt passes.

5. The device according to claim 1, wherein the protuberance comprises a body terminating in a widened end.

6. The device according to claim 1, wherein the slideway is equipped with a stop for positioning of the protuberance in the slideway.

7. The device according to claim 4, wherein the actuator comprises a soft steel core prolonged by the protuberance, and the bolt passes through these the soft steel core and the protuberance from one end to the other.

8. The device according to claim 7, wherein the soft steel core is surrounded by a magnetic coil and a rubber spring, and wherein said spring is located between the wall and said coil when said device is mounted to said wall.

9. The device according to claim 8, wherein the core is blocked in translation relative to the bolt, by means of a washer and a nut, located at an end of said core.

10. The device according to claim 1, wherein the slideway is equipped with an anti-backup device which engages the protuberance when the protuberance is in the slideway to prevent the protuberance (18) from moving in the opposite direction of its insertion in said slideway.

11. The device according to claim 10, wherein the anti-backup device comprises of a leaf spring, suitable to deform during the insertion of the protuberance in said slideway, and suitable to return to its relaxed position after passage of said protuberance over said leaf spring.

12. The device according to claim 10, wherein the anti-backup device comprises a set screw emerging in the groove of the slideway.

13. An automotive vehicle in combination with the mounting device of claim 1.
